(19) United States
(12) Patent Application Publication
(10) Pub. No.: US 2004/0080454 A1
(43) Pub. Date: Apr. 29, 2004

(54) Methods and systems for determining the position of a mobile terminal using digital television signals

(76) Inventor: William O. Camp JR., Chapel Hill, NC (US)

Correspondence Address: MYERS BIGEL SIBLEY & SAJOVEC, PO BOX 37428, RALEIGH, NC, 27627, US

(21) Appl. No.: 10/278,511

(22) Filed: Oct. 23, 2002

(51) Int. Cl. G01S 3/02

(52) U.S. Cl. 342/464

(57) ABSTRACT

Methods, circuits and mobile terminals determine the position of the mobile terminal. The position of the mobile terminal is estimated based on range estimates derived from digital television signals received at the mobile terminal from at least one digital television transmitter and based on range estimates derived from signals received at the mobile terminal from at least one other type of transmitter. For example, the other type of transmitter may be a GPS satellite or a base station of a mobile telecommunications network. Accordingly, by combining ranging signals from multiple sources, flexibility in acquiring enough signals to estimate a position of the mobile terminal may be increased and the estimation of the position may not require the use of weak digital television signals.

### BACKGROUND OF THE INVENTION

The present invention relates to the field of communications in general and more particularly, to determining the position of a mobile terminal device.

It is desirable, and in certain places mandated by law, that mobile telecommunication network providers be able to determine an approximate geographical location of a mobile terminal (MT), such as, for example, an actively communicating cellular telephone.

A variety of MT location techniques have been proposed. These location techniques include uplink signal location, downlink signal location, Global Positioning System (GPS) based approaches and approaches based on digital television signals. For “uplink signal” location techniques, the mobile telecommunications network is typically configured to determine where the MT is located based on ranging measurements associated with one or more uplink signals. These uplink signals are transmitted by the MT and received by a requisite number of receivers having known locations, such as, for example, cellular telephone base stations (BSs). For the “downlink signal” location techniques, the mobile telecommunications network is typically configured to determine where the MT is located based on ranging measurements associated with the reception, by the MT, of downlink signals from a requisite number of transmitters having known locations.

FIG. 1 illustrates a conventional terrestrial mobile (wireless) telecommunications network 20 that may implement any one of a variety of known wireless communications standards including uplink and downlink signals. The wireless network may include one or more wireless mobile stations 22 that communicate with a plurality of cells 24 served by base stations 26 and a mobile telephone switching office (MTSO) 28. Although only three cells 24 are shown in FIG. 1, a typical cellular radiotelephone network may comprise hundreds of cells, and may include more than one MTSO 28 and may serve thousands of wireless mobile stations 22.

The cells 24 generally serve as nodes in the network 20, from which links are established between wireless mobile stations (terminals) 22 and a MTSO 28, by way of the base stations 26 servicing the cells 24. Each cell 24 will have allocated to it one or more dedicated control channels and one or more traffic channels. The control channel is a dedicated channel that may be used for downlink transmission (network to mobile) of cell identification and paging information. The traffic channels carry the voice and data information. Through the network 20, a duplex (downlink and uplink) radio communication link 30 may be effected between two wireless mobile stations 22 or between a wireless mobile station 22 and a landline telephone user 32 via a public switched telephone network (PSTN) 34. The function of the base station 26 is commonly to handle the radio communications between the cell 24 and the wireless mobile station 22. In this capacity, the base station 26 functions chiefly as a relay station for data and voice signals. It is also know to provide mobile telecommunications networks in which the base stations are satellites, having associated coverage areas, rather than terrestrial base stations.

The other location approaches generally use location services not associated with either the uplink or downlink signals used in the mobile telecommunications network. In a typically GPS application, the GPS receivers collect and analyze ranging measurements from signals transmitted by GPS satellites having known locations. More recently, it has been proposed that digital television signals could be used for location of a MT. As described in “Positioning Using the ATSC Digital Television Signal,” Rabinowitz, M. and Spilker, J., Rosum Corporation Whitepaper, www.rosum.com (circa 2001), digital television is being implemented in the United States and is expected to have broad coverage by May of 2003. Thus, digital television signals should be available, at least in the United States, for terrestrial digital television transmitters having determinate locations. The Rosum Corporation Whitepaper, proposes a technique for determining range information to digital television transmitters using the synchronization fields of the digital television signal.

As shown in FIG. 3, a digital television data frame 60, as specified by the ATSC standard, includes a plurality of blocks, each of which has a length of 832 symbols. The data frame 60 includes a first and second synchronization block 62 with 312 data blocks 64 between the synchronization blocks 62 and a further 312 data block 64 following the second synchronization block 62. Furthermore, each of the blocks 62, 64 is specified as including 4 symbols used for synchronization purposes The proposed modulation scheme for the ATSC signal uses 8-ary Vestigial Sideband Modulation (8-ary VSB).

As illustrated in FIG. 2, GPS is a space-based triangulation system using satellites 42 and GPS control computers 48 to measure positions anywhere on the earth. GPS was first developed by the United States Department of Defense as a navigational system. The advantages of this navigational system over land-based systems are that it is not limited in its coverage, it provides continuous 24-hour coverage, which may be highly accurate regardless of weather conditions. While the GPS technology that provides the greatest level of accuracy has been retained by the government for military use, a less accurate service has been made available for civilian use. In operation, a constellation of 24 satellites 42 orbiting the earth continually emit a GPS radio signal 44. A GPS receiver 46, e.g., a hand-held radio receiver with a GPS processor, receives the radio signals from the closest satellites and measures the time that the radio signal takes to travel from the GPS satellites to the GPS receiver antenna. By multiplying the travel time by the speed of light, the GPS receiver can calculate a range for each satellite in view. Ephemeris information provided in the satellite radio signal typically describes the satellite's orbit and velocity, thereby generally enabling the GPS processor to calculate the position of the GPS receiver 46 through a process of triangulation. It is known to include a GPS receiver 46 in a mobile station 22 to provide position location functionality to the mobile station 22.

The startup of a GPS receiver typically requires the acquisition of a set of navigational parameters from the navigational data signals of four or more GPS satellites. This process of initializing a GPS receiver may often take several minutes. The duration of the GPS positioning process is directly dependent upon how much information a GPS receiver has initially. Most GPS receivers are programmed with almanac data, which coarsely describes the expected satellite positions for up to one year ahead. However, if the GPS receiver does not have some knowledge of its own approximate location, then the GPS receiver cannot find or acquire signals from the visible satellites quickly enough, and, therefore, cannot calculate its position quickly. Furthermore, it should be noted that a higher signal strength is typically needed for capturing the C/A Code and the navigation data at start-up than is needed for continued monitoring of an already-acquired signal. It should also be noted that the process of monitoring the GPS signal may be significantly affected by environmental factors. Thus, a GPS signal which may be easily acquired in the open typically becomes harder to acquire when a receiver is under foliage, in a vehicle, or worst of all, in a building.

These various known location techniques may, among other thing, include collecting ranging measurements such as, for example, a time of arrival (TOA), a time difference of arrival (TDOA), an observed time difference (OTD), or the like. These ranging measurements are typically gathered by detecting one or more measurement features within the transmitted/received signal(s). Each of the various location techniques has certain limitations on their accuracy. By way of example, various TOA, TDOA, and OTD location techniques that utilize existing BSs typically require that at least three (3) or more BSs receive the transmitted uplink signal from the MT, or, conversely, that the MT receive transmitted downlink signals from at least three BSs to perform the locating process. Similarly, with respect to the GPS approach, a GPS receiver generally needs to receive transmitted signals from at least four (4) GPS satellites to perform the complete locating process (although some information may be generated based on transmitted signals received from three GPS satellites).

Unfortunately, there is not always a clear line-of-sight (LOS) between the MT and the requisite number of known location transmitter(s)/receiver(s). For example, in an urban environment, the LOS is often blocked by building and/or other structures, while in certain other environments the naturally occurring terrain and/or other features (e.g., mountains, canyons, forests, weather, etc.) can reduce the LOS, attenuate the transmitted signals, or produce multipath signals at the receiver. For many higher frequency signals or weaker signals, the loss of LOS or the introduction of such obstacles, can render the location technique significantly inaccurate, or completely unavailable.

### SUMMARY OF THE INVENTION

Embodiments of the present invention include methods, terminals and circuits for determining the position of a mobile terminal. The position of the mobile terminal is estimated based on range estimates derived from digital television signals received at the mobile terminal from at least one digital television transmitter and based on range estimates derived from signals received at the mobile terminal from at least one other type of transmitter. For example, the other type of transmitter may be a GPS satellite or a base station of a mobile telecommunications network. Accordingly, by combining ranging signals from multiple sources, flexibility in acquiring enough signals to estimate a position of the mobile terminal may be increased and the estimation of the position may not require the use of weak digital television signals.

In further embodiments of the present invention, the digital television signals are a first type of signal and estimating the position of the mobile terminal includes receiving a digital television signal from the digital television transmitter at the mobile terminal and a second type of signal, different from a digital television signal, from the other type of transmitter. A time of flight is measured for received ones of the digital television signals and for received ones of the second type of signal. The time of flight measurements are converted to range values and the position of the mobile terminal is estimated using the range values to provide a position estimate based on both the digital television signals and the second type of signal.

In other embodiments of the present invention, at least three range values are generated. The total number of received digital television signals and signals of the second type is greater than three and at least one of the received digital television signals is selected to use for measuring a time of flight based on a first signal quality criterion. In addition, at least one of the received second type of signals is selected to use for measuring a time of flight based on a second signal quality criterion. The first signal quality criterion and the second signal quality criterion may be a minimum received signal strength and may be the same or different. A plurality of received signals having a best signal quality among the received signals may be identified, including one or more digital television signal, and the time of flight may be measured for only the identified plurality of received signals. The plurality of received signals may be less than five received signals.

In further embodiments of the present invention, one or more third type of signals, different from a digital television signal and the second type of signal, are received at the mobile terminal. A time of flight is also measured for received ones of the third type of signal and the position of the mobile terminal is estimated using the range values to provide a position estimate based on the digital television signals, the second type of signal and the third type of signal.

In other embodiments of the present invention, measuring a time of flight for received ones of the digital television signals and measuring a time of flight for received ones of the second type of signal includes using a single time measuring unit to measure the respective time of flights for both the digital television signals and the second type of signal. The single time measuring unit may be located within the mobile terminal and may include a frequency converter and a correlator circuit.

In further embodiments of the present invention, estimating the position of the mobile terminal includes providing the range estimates to a remote position determination server. The estimate of the position of the mobile terminal is received from the remote position determination server/circuit.

In other embodiments of the present invention, methods are provided for determining the position of a mobile terminal including estimating the position of the mobile terminal based on range estimates derived from digital television signals received at the mobile terminal from at least one digital television transmitter and based on range estimates derived from signals transmitted by the mobile terminal to at least one base station of a mobile telecommunications network. In such embodiments, estimating the position of the mobile terminal may include transmitting at least one second type of signal to the base station from the mobile terminal and measuring a time of flight for received ones of the digital television signals and for transmitted ones of the second type of signals received at the base station. A plurality of base stations may be used and operations may include synchronizing clocks associated with the plurality of base stations and with the one digital television transmitter(s).

In further embodiments of the present invention, position determination circuits for a mobile terminal are provided including a television signal processing circuit configured to process digital television signals received from digital television transmitters and a second type of signal processing circuit configured to process ranging signals received from an alternate type of transmitter different from the digital television transmitters. A position computation circuit estimates a position of the mobile terminal based on a range estimate to at least one of the digital television transmitters derived from a digital television signal received from the the digital television transmitter(s) and based on a range estimate to at least one transmitter of the alternate type of transmitter derived from a received ranging signal from the alternate type of transmitter.

In other embodiments of the present invention, position determination circuits for a mobile terminal are provided including a television signal processing circuit configured to process digital television signals received from digital television transmitters and a second type of signal processing circuit configured to process ranging signals received from a base station of a mobile telecommunications network. A position computation circuit estimates a position of the mobile terminal based on a range estimate to at least one of the digital television transmitters derived from a digital television signal received from the the digital television transmitters and based on a range estimate to the base station of a mobile telecommunications network transmitter derived from signals transmitted by the mobile terminal to the base station of a mobile telecommunications network.

In yet further embodiments of the present invention, mobile terminals are provided including a receiver configured to receive digital television signals from digital television transmitters and to receive ranging signals from an alternate type of transmitter different from the digital television transmitters. A television signal processing circuit is configured to process the received digital television signals. A second type of signal processing circuit is configured to process the ranging signals received from an alternate type of transmitter different from the digital television transmitters. A position computation circuit estimates a position of the mobile terminal based on a range estimate to at least one of the digital television transmitters derived from a digital television signal received from the digital television transmitter(s) and based on a range estimate to at least one transmitter of the alternate type of transmitter derived from a received ranging signal from the alternate type of transmitter. The position computation circuit may include a processor that provides the range estimates to a remote position determination server and that receives the estimate of the position of the mobile terminal from the remote position determination server.

In other embodiments of the present invention, methods are provided for determining the position of a mobile terminal. Digital television signals are received from a source digital television transmitter at the mobile terminal. The received digital television signals include an identification of one or more other ranging information transmitters in a vicinity of the mobile terminal and a timing relation between a timing of the source digital television transmitter and a timing of the other ranging information transmitter(s). Ranging signals are received from the other ranging information transmitter(s) based on the received timing relation. The position of the mobile terminal is estimated based on range estimates derived from the digital television signals received at the mobile terminal from the source digital television transmitter and from the ranging signals received from the at other ranging information transmitter(s). The other ranging information transmitter(s) may be other digital television transmitter(s) and the other digital television signal(s) may be acquired based on the received timing relation. The received the digital television signals from the other digital television transmitter(s) may be provided by a tuner to a monitor for viewing. Corresponding position determination circuit may also be provided.

### BRIEF DESCRIPTION OF THE DRAWINGS

FIG. 1 is a schematic block diagram illustrating a conventional terrestrial wireless communication system;

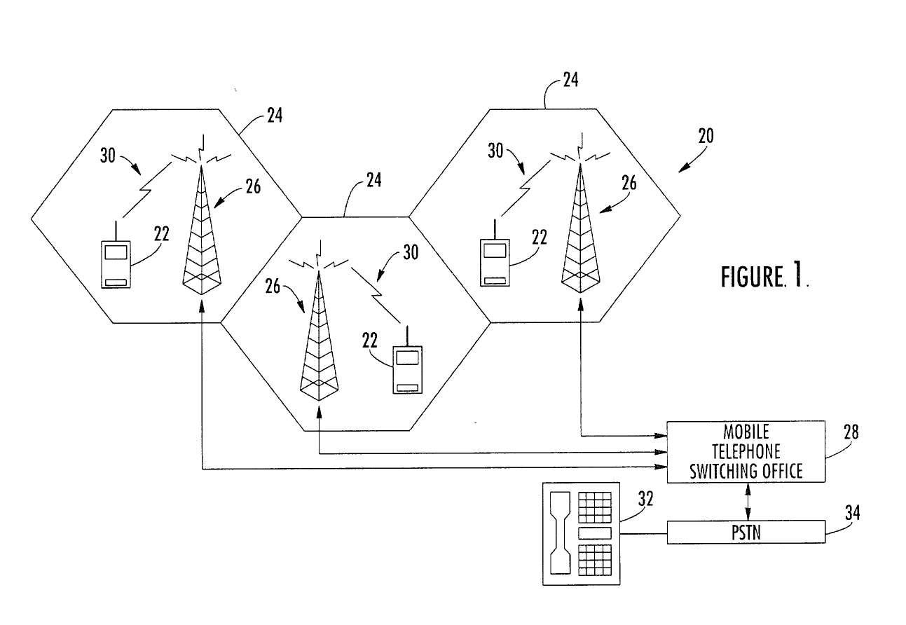

FIG. 2 is schematic block diagram illustrating a GPS system;

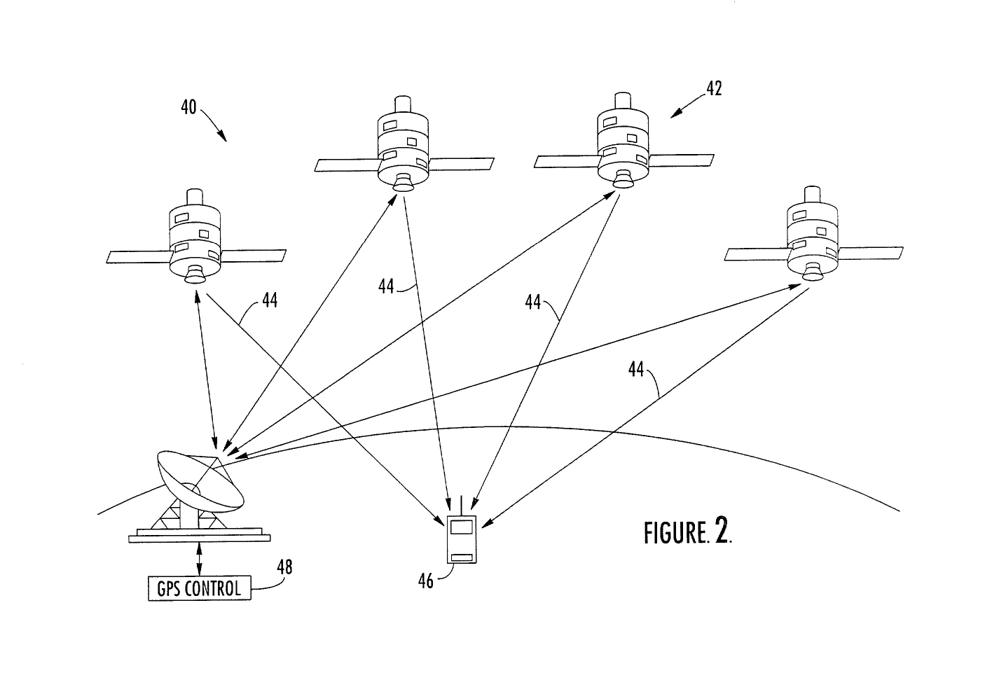

FIG. 3 is a schematic block diagram of a digital television frame according to the ATSC standard;

FIG. 4 is a schematic block diagram illustrating a mobile terminal including a position computation device according to embodiments of the present invention;

FIG. 5 is a flow chart illustrating operations for estimating the position of a mobile terminal according to embodiments of the present invention;

FIG. 6 is a flow chart illustrating operations for estimating the position of a mobile terminal according to further embodiments of the present invention;

FIG. 7 is a flow chart illustrating operations for estimating the position of a mobile terminal according to yet further embodiments of the present invention; and

FIG. 8 is a flow chart illustrating operations for estimating the position of a mobile terminal according to yet further embodiments of the present invention.

### DETAILED DESCRIPTION

The present invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As will be appreciated by one of skill in the art, the present invention may be embodied as a method, circuit or mobile terminal. Accordingly, the present invention may take the form of an entirely hardware embodiment, an entirely software embodiment or an embodiment combining software and hardware aspects, all generally referred to herein as a “circuit.”

Computer program code for carrying out operations of the present invention may be written in an object oriented programming language such as Java®, Smalltalk or C++, a conventional procedural programming languages, such as the “C” programming language, or lower-level code, such as assembly language and/or microcode. The program code may execute entirely on a single processor and/or across multiple processors, as a stand-alone software package or as part of another software package.

The present invention is described below with reference to flowchart illustrations and/or block and/or flow diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart and/or block and/or flow diagram block or blocks.

These computer program instructions may also be stored in a computer-readable memory that can direct a computer or other programmable processor to function in a particular manner, such that the instructions stored in the computer-readable memory produce an article of manufacture including instruction means which implement the function specified in the flowchart and/or block diagram block or blocks.

The computer program instructions may also be loaded onto a computer or other programmable data processor to cause a series of operational steps to be performed on the computer or other programmable processor to produce a computer implemented process such that the instructions which execute on the computer or other programmable processor provide steps for implementing the functions or acts specified in the flowchart and/or block diagram block or blocks.

In accordance with certain embodiments of the present invention, a mobile terminal (MT), such as, for example, an actively communicating cellular telephone, is located by combining digital television signal locating technology with an alternate location technology, such as one or more associated with a mobile telecommunication network and/or the Global Positioning System (GPS).

By way of background, each of these discrete systems employs location techniques having certain characteristics in common. For example, each of these systems uses the collection of a requisite number of ranging measurements from signals passed between transmitter(s) and receiver(s), wherein either the transmitter(s) or the receiver(s) have known or determinable locations (i.e., positions). Further, each of the collected ranging measurements can generally be converted from a time interval measurement to a corresponding distance measurement, for example, by multiplying by the speed of light or an expected speed of transmission associated with the signal. Once the conversion from time to distance has been accomplished, then traditional triangulation, or other like mathematical techniques can be used to determine the positional coordinates of the MT, based on the known locations and calculated distances.

In the case of a time of arrival (TOA) location technique, for example, the positions of the base stations (BSs) are generally known and do not change over time. The ranging measurements can occur in a variety of ways, including: 1) having each BS measure the TOA of a synchronized word (synch word), as broadcast repeatedly in an uplink signal from the MT; 2) having each BS measure the timing advance required for communication with the terminal; and/or 3) having the MT separately measure a TOA based on a synch word in the transmitted downlink signal from each of the BSs. Assuming that the MT is positioned within a relatively planar environment, distance information from three (3) BSs is generally required to solve for x and y positional coordinates on the ground and the unknown time of broadcast of the synch word (either uplinked or downlinked).

In the case of the GPS location technique, as discussed above, the positions of the GPS satellites vary with regard to time. Thus, a GPS receiver generally needs to receive an accurate measurement of time from the GPS satellites (or an accurate GPS-related source on the ground) in order to know the positions of the GPS satellites at the time of the ranging measurements. The ranging measurements between the GPS receiver and each of at least four (4) GPS satellites occurs by: 1) finding the starting point on the 1023 chip long Gold code sequence within the signal transmitted by each GPS satellite; 2) finding the start time of a bit edge; and 3) finding the start time of the data message. The resulting “time of flight” for the signal received from each GPS satellite is then converted to distance. The resulting four (4) range measurements allow for a solution to the GPS receiver's position in x, y and z coordinates and for determination of the unknown time difference between the GPS time and the GPS receiver's independent clock.

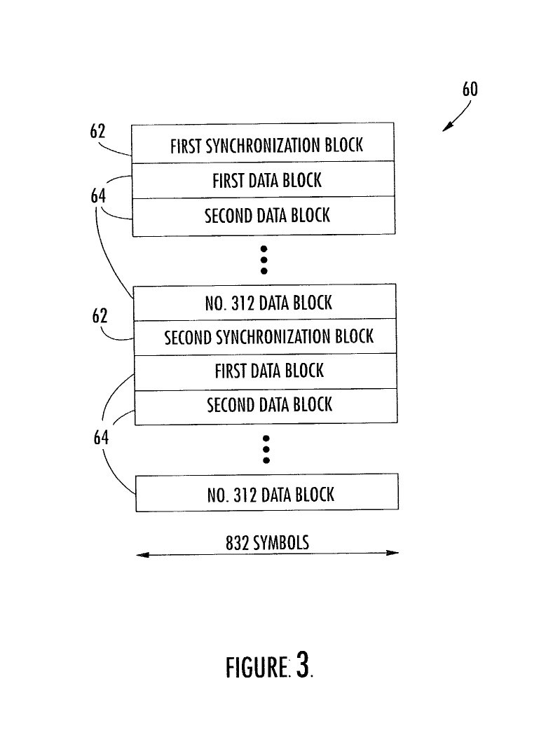

Similarly, for the digital television system, digital television signals are transmitted from digital television transmitters having a determinate location. The transmitted signals have a framing structure, such as that illustrated in FIG. 3, and an associated transmission time reference at the respective transmitters. A time offset may be determined for synchronization to a received digital television signal, which time offset may be used in determining, for example, time of flight values from the respective transmitters. Known information, such as a synchronization signal, or data symbols, may be used in determining the time offset. An approach to such ranging estimation using digital television signals suitable for use in embodiments of the present invention is further described in the Rostum Corporation White Paper, which is incorporated herein by reference as if set forth in its entirety.

Thus, in the examples above, the underlying location process for the digital television signals and either the mobile telecommunications network and/or GPS essentially use signals received from certain known positions, and gathering ranging measurements from a sufficient number of signals to solve for the MT's location. These common characteristics and others will be described in more detail below to show how the present invention may advantageously combine location techniques and/or locating processes by combining the use of digital television signals with other approaches. Further discussion of mathematical solutions suitable for use with the combined signal type operations of the present invention are provided in U.S. Pat. No. 6,252,543, which is incorporated herein by reference as if set forth in its entirety.

In accordance with certain embodiments of the present invention, the signal sources can include any viable combination of terrestrial-based transmitters, and space-based transmitters having static and/or dynamic positions with respect to time. Those skilled in the art will further recognize that the methods and devices in accordance with the present invention can, therefore, be adapted for use in combining a digital television signal based approach with a variety of different types of mobile terminals, other system's transmitters, and/or special purpose transmitters. For convenience, however, the exemplary embodiments described herein are directed towards combining digital television signal approaches with certain aspects of a conventional mobile telecommunications network (e.g., a cellular network) and/or an existing GPS, such as described in U.S. Pat. No. 6,252,543.

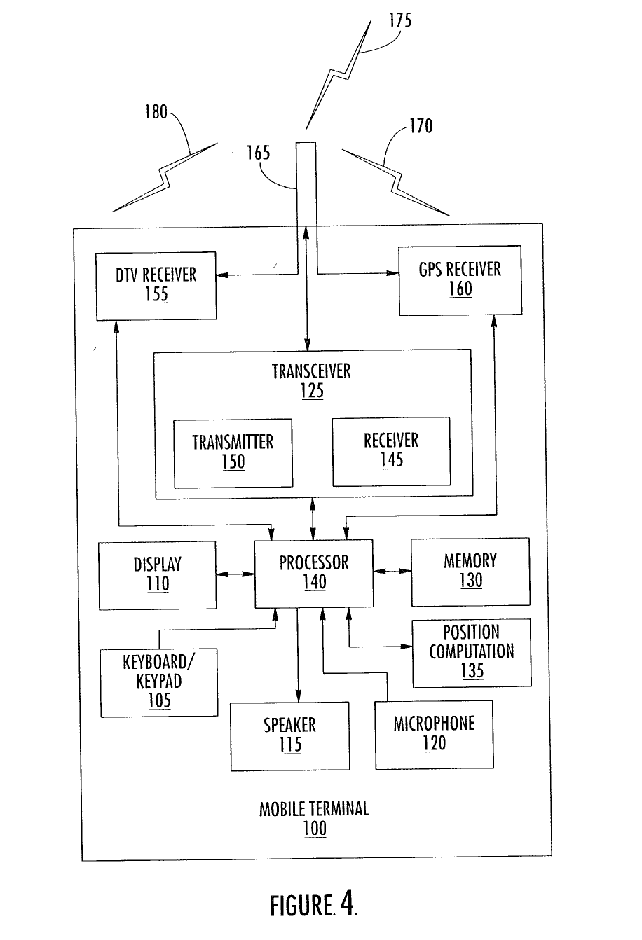

Embodiments of the present invention will now be further described with reference to the schematic block diagram illustration of a mobile terminal 100 in FIG. 4. FIG. 4 illustrates a mobile wireless terminal 100, a digital television signal 170 from a digital television transmitter, a GPS signal 175 and a base station downlink/uplink signal 180. The mobile terminal 100 may comprise a keyboard/keypad 105, a display 110, a speaker 115, a microphone 120, a network transceiver 125, and a memory 130 that communicate with a processor 140. The network transceiver 125 typically comprises a transmitter circuit 150 and a receiver circuit 145, which respectively transmit outgoing radio frequency signals to a base station 26 and receive incoming radio frequency signals from the base station 26 via an antenna 165. While a single antenna 165 is shown in FIG. 4, it is to be understood that multiple antennas and/or different types of antennas may be utilized based on the types of signals being received. The radio frequency signals transmitted between the mobile terminal 100 and the base station 26 may comprise both traffic and control signals (e.g., paging signals/messages for incoming calls), which are used to establish and maintain communication with another party or destination, and may provide uplink and/or downlink communications. However, the present invention is not limited to such two-way communication systems.

The foregoing components of the mobile terminal 100 may be included in many conventional mobile terminals and their functionality is generally known to those skilled in the art. It should be further understood, that, as used herein, the term “mobile terminal” may include a cellular radiotelephone with or without a multi-line display; a Personal Communications System (PCS) terminal that may combine a cellular radiotelephone with data processing, facsimile and data communications capabilities; a Personal Data Assistant (PDA) that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be refeired to as “pervasive computing” devices.

Also shown in the mobile terminal 100 of FIG. 4 is a digital television (DTV) receiver 155 and a GPS receiver 160. The DTV receiver 155, in cooperation with the processor 140, provides a television signal processing circuit configured to process digital television signals received from digital television transmitters. The DTV receiver may further include or be associated with a tuner that provides received DTV signals to a monitor for viewing. The GPS receiver 160, in cooperation with the processor 140, provides a processing circuit configured to process ranging signals received from GPS satellites 42. Thus, the processor 140, in combination with either the transceiver 125 or the GPS receiver 160, provides an alternate type of signal processing circuit to process ranging signals received from alternate types of transmitters, different from the digital television transmitters. It is further to be understood that the network transceiver 125, as shown in FIG. 4, may include a transmitter 150 allowing the network transceiver 125 to support signal processing for transmitting ranging signals from the mobile terminal 100 to a base station 26 that is configured to perform uplink based ranging measurement calculations (or is associated with a position determination circuit able to make such calculations).

As shown in FIG. 4, the mobile terminal 100 further includes a position computation circuit 135 that estimates a position of the mobile terminal 100 based on range estimates to one or more digital television transmitters, which estimates are derived from received digital television signals. The range estimates are also derived based on signals from at least one transmitter of an alternate type, such as a base station 26 or a GPS satellite 42. The position computation circuit 135 may further be configured to provide the resulting range estimates to a remote position determination server (circuit) and to receive estimates of the position of the mobile terminal 100 from the remote position determination server. For example, a remote position determination server may be implemented in a base station 26, a MTSO 28, or other component of the mobile telecommunications network 20. In other embodiments, the position computation circuit 135 performs the calculations to estimate a position of the mobile terminal 100 at the mobile terminal 100. Furthermore, while the position computation circuit 135, and the processor 140 are shown as distinct blocks in the illustration of FIG. 4, it is to be understood that the functionality of these blocks may be combined into a single processor or spread across a plurality of different processors and/or other hardware configured to operate in the manner described herein.

Although the present invention may be embodied in communication devices or systems, such as the mobile terminal 100, the present invention is not limited to such devices and/or systems. Instead, the present invention may be embodied in any method, transmitter, communication device, communication system, or computer program product that is configured to receive (or transmit) signals suitable for ranging measurements from at least two different types of systems, including digital television signals.

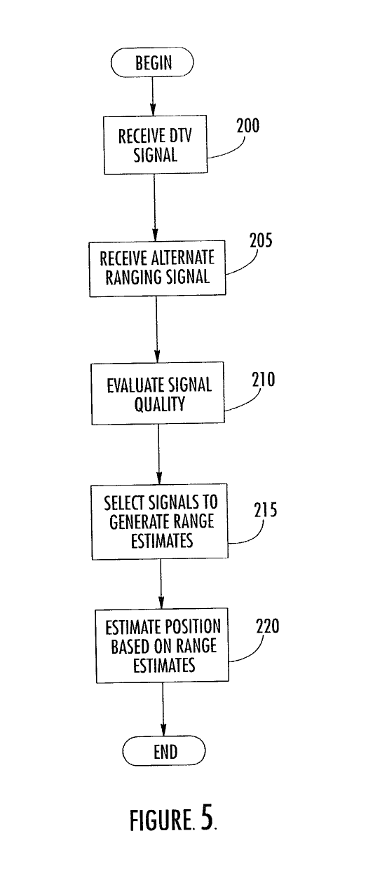

FIGS. 5 through 8 are flowchart illustrations of operations that may be carried out by a mobile terminal 100 according to embodiments of the present invention. Operations related to determining the position of a mobile terminal according to embodiments of the present invention will now be described with reference to the flow chart diagram of FIG. 5. As shown in FIG. 5 digital television signals are received from one or more digital television transmitters at the mobile terminal 100 (Block 200). Furthermore, a second, alternate type of signal, different from the digital television signal, is received from at least one other type of transmitter at the mobile terminal 100 (Block 205).

As will be understood from the description of GPS, telecommunications network based and digital television signal based location techniques above, a plurality of signals generated by determinate location sources may be received from each of a number of different transmitter type systems. However, as discussed above, the calculation of the position of the mobile terminal generally requires less than 5 received signals to be used for range measurements, although use of a greater number of received signals may provide for improved performance. For example, with a GPS system, measurements are typically based on ranging signals from 4 GPS satellites. Thus, in various embodiments of the present invention, operations may include evaluating the signal quality of the received signals (Block 210) and selecting ones of the received signals to use in generating the range estimates (Block 215). Furthermore, operations at Block 205 may include receiving signals of two or more distinct types different from digital television signals. For example, GPS signals and telecommunications network downlink signals may be received at Block 205 and position estimates for the mobile terminal 100 may be based on a combination of range estimates from 2, 3 or more different types of transmitter systems.

Signal quality evaluation operations at Block 210 may be applied to ranging signals received from digital television transmitters, GPS satellites or base stations of the mobile telecommunications network as received at the mobile terminal 100. Furthermore, a distinct signal quality criterion may be applied to each type of signal or a common signal quality criterion may be applied regardless of the transmission source for the received signals. In various embodiments of the present invention, signal quality measurements and corresponding criterion may be received signal strength measurements compared to a minimum acceptable signal strength.

Alternative embodiments of the present invention may utilize more than the minimum required number of received signals from different sources in deriving a position estimate by appropriately combining the ranging information derived from the sources. For example, range values from each received signal source may be weighted based on the signal quality of the received signals. In some embodiments, the range estimate from each source is scaled (for example, multiplied) by the signal to noise ratio (S/N) of that received signal to provide greater weight to the ranges estimated based on high quality signals in deriving a position estimate.

Where the total number of received ranging signals is greater than the number of range estimates to be used in estimating the position of the mobile terminal 100, the received signals that are to be used in generating range estimates are selected at Block 215. The selection may be based upon the signal quality evaluations performed at Block 210. Thus, one or more digital television signals may be selected at Block 215 based on a first signal quality criterion and one or more other received signal from other types of transmitters may be selected at Block 215 based on a second signal quality criterion. In further embodiments, a plurality of received signals having a best signal quality among the received signals are identified at Block 215, including at least one digital television signal, and range estimates are generated for only the identified plurality of received signals. For example, the best signal quality may be the signals having a signal strength, error rate, etc. so as to be most readily/rapidly acquired for use in ranging measurements and/or providing the most reliable/repeatable ranging measurements.

The range values may then be generated from the selected signals and the position of the mobile terminal 100 may be estimated using the generated range value estimates (Block 220). The position estimate may be generated at the mobile terminal 100 or information used in generating the estimate may be transmitted by the mobile terminal 100 to a remote location and the position estimate may then be transmitting back to the mobile terminal 100 as needed. In further embodiments of the present invention, intermediate measurements, such as the time of arrival, may be transmitted to a remote position determination circuit and further processed values, such as range value estimates, may be returned to the mobile terminal 100 for use in estimating the position of the mobile terminal at the mobile terminal 100. As will be generally understood by those of skill in the art, the location of the signal sources and their relative timing generally must be known in calculating a final location for the mobile terminal 100, regardless of where the calculations are executed. As such methods for calculation of a final location based on ranging information are generally known, they will not be described further herein.

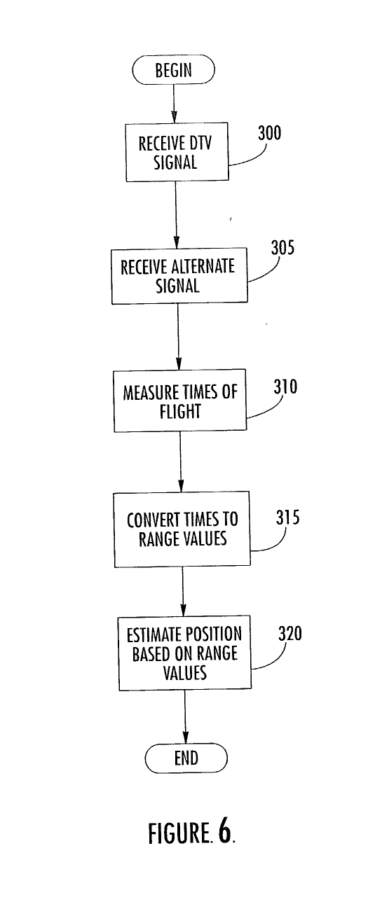

Operations in accordance with the embodiments of the present invention will now be further described with reference to the flow chart illustration of FIG. 6. For the embodiments illustrated in FIG. 6, digital television signals and alternate signals from at least one other type of transmitter are received at Blocks 300 and 305 in a manner substantially as described with reference to FIG. 5 for Blocks 200 and 205. The operations as will be described with reference to Blocks 310, 315 and 320 of FIG. 6 generally correspond to operations described for Block 220 of FIG. 5 and is to be understood that the embodiments illustrated in FIG. 6 may also include signal quality evaluation and signal selection operations as described with reference to the embodiments of FIG. 5.

As shown in FIG. 6, the times of flight for received ones of the digital television signals and for received ones of the alternate type of signal(s) are measured (Block 310). The time of flight measurements are converted to range values or estimates (Block 315). The position of the mobile terminal is then estimated using the range values to provide a position estimate that is based on both digital television signals and one or more alternate types of signals. Generally, three or more range values will be generated at Block 315.

In particular embodiments of the present invention, a single time measuring unit is used to measure the respective times of flight of both the digital television signals and the one or more alternate types of signals at Block 310. The single time measuring unit may be provided by a means for generating such a single time measuring unit located, for example, in the position computation circuit 135 (FIG. 4). Furthermore, in particular embodiments, the means for generating and using a single time measuring unit in the mobile terminal 100 may include a frequency converter and correlater circuit(s).

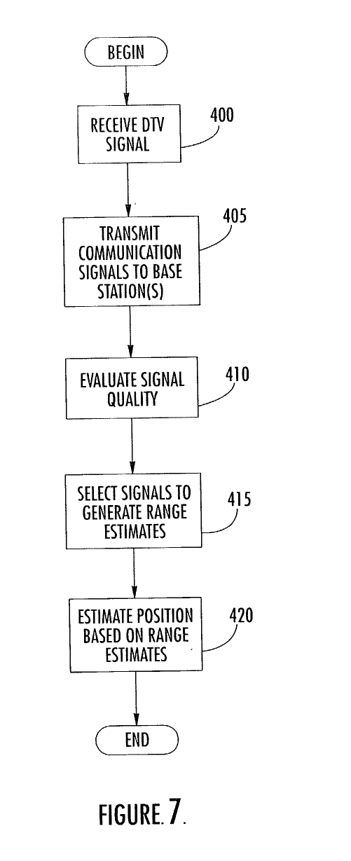

Operations related to determining the position of a mobile terminal based on an uplink signal from a mobile telecommunications network transmitter will now be described with reference to the flow chart illustration of FIG. 7. Operations relative to Blocks 400, 410, 415 and 420 proceed generally as described previously with respect to Blocks 200, 210, 215 and 220 of FIG. 5. However, for the embodiments illustrated in FIG. 6, the position of the mobile terminal is estimated based on range estimates derived from digital television signals received at the mobile terminal and based on range estimates derived from signals transmitted by the mobile terminal 100 to one or more base stations 26 of the mobile telecommunications network 20 that are configured to support such ranging operations. Accordingly, operations at Block 405 in FIG. 7 include transmitting an uplink type signal suitable for ranging to one or more base stations 26 from the mobile terminal 100.

As will be understood by those of skill in the art in light of the description of uplink type locating systems above, the receiving base station, or an associated position determination circuit, may make timing measurements or other ranging measurements based on the uplink transmitted ranging signals and may return such signals to the mobile terminal 100 for use in estimating the position at the mobile terminal 100. Alternatively, ranging value estimates generated at the mobile terminal 100, for example, from received digital television signals, may be sent to the base station 26, or other remote position determination circuit to combine with the uplink ranging signal measurements to generate an estimate of the position of the mobile terminal 100, which estimate may be returned to the mobile terminal 100 as needed. Furthermore, signal quality measurements can be applied to the uplink ranging signals received at the base stations 26 and a quality criterion may be applied to such measurements in selecting what range value estimates to use in estimating the position of the mobile terminal as described previously with reference to FIGS. 5 and 6.

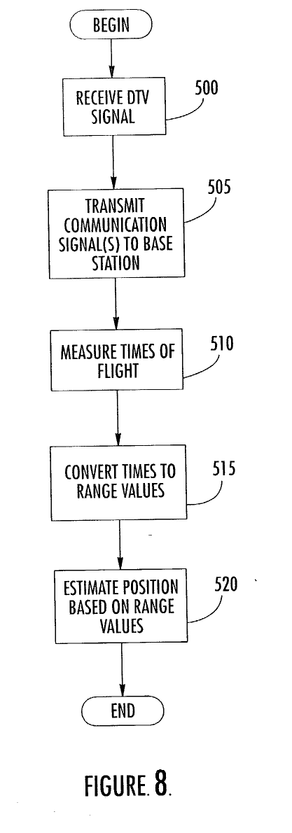

Referring now to FIG. 8, further embodiments of the present invention using uplink ranging signals will now be described. For the embodiments illustrated in FIG. 8, operations at Blocks 500 and 505 proceed in a manner as described with reference to Blocks 400 and 405 of FIG. 7 and need not be further described. Furthermore, operations as illustrated at Blocks 510, 515 and 520 may generally proceed as described with reference to Blocks 310, 315 and 320 of FIG. 6. However, it will be understood that the time of flight measurements at Block 510 for the uplink ranging signals will represent a time of flight from the mobile terminal 100 to the receiving base station 26, which time of flight measurements may be performed at the base station 26 or performed at the mobile terminal 100, using for example, time of receipt information transmitted to the mobile terminal 100 from the base station 26 and timing offset information synchronizing the mobile terminal 100 and the base station 26. Thus, more generally, all the ranging type measurements based on signals transmitted from the mobile terminal 100 to a determinate location receiver or received at the mobile terminal 100 from a determinate location transmitter of any type generally may be based on synchronizing of clocks associated with the remote determinate locations and the clock of the mobile terminal 100. Furthermore, the clocks of the different transmitters used in the estimating the position of the mobile terminal 100 may in turn be synchronized to each other. Such clock synchronizing can be provided by adjusting (calibrating) the clocks at the respective locations or by use of “virtual” clocks provided by determining respective offsets to provide synchronized clock values for use in position determination operations.

Additional benefits of timing synchronization may be applied to reduce the search space for synchronizing to the received signals from, for example, a GPS satellite or the digital television transmitters. With respect to reducing the search space for signals from GPS satellites, exemplary operations suitable for use in the present invention are described in U.S. Pat. No. 6,070,078 and U.S. Pat. No. 6,295,023, both of which are incorporated herein by reference as if set forth in their entirety.

In particular embodiments of the present invention, communication of timing information is provided that may allow for a more effective searching for the synchronization symbols of received digital television signals in order to more rapidly acquire such signals so they may be used for generating ranging value estimates in locating the position of the mobile terminal 100. Providing this timing information may allow the digital television receiver 155 to be less than a fully functional receiver, which would be demodulating the signal, and ensuring that it meets certain signal quality criteria for acceptable viewing. To be more specific, digital television receiver 155 may only need to locate in time the synchronization burst, and the processing gain for this particular function is generally quite large due to correlation gain. This correlation gain can be further increased by knowing approximately where to locate the synchronization burst in time, which may reduce interference further. Therefore, the digital television receiver 155 may be enabled to accept more interference than would normally be permitted in its usual mode of operation. This interference could come, for example, from adjacent channels and stronger nearby DTV transmitters. The ability to increase correlation gain by means of longer integrations over very narrow time windows may allow use of a digital television receiver 155 that has less channel selectivity and front end linearity than it would normally have for viewing television images. This may result in a simpler and less expensive implementation of the digital television receiver 155 for use in the mobile terminal 100.

For example, weaker digital television signals could be more readily correlated and averaged over long correlation times with the time involved in searching over the entire range of possible time shifts is reduced by reducing the number of time shifts that need to be searched. Accordingly, a significant reduction in the cost of the associated hardware may be realized, particularly in combination with mobile terminals 100, including cellular receivers (such WCMDA cellular receivers) with very little additional preselection filtering.

Such benefits may be provided in accordance with the present invention by providing relative timing and/or phase of synchronizing burst information related to digital television transmitters that are visible to the mobile terminal 100. A variety of approaches may be successfully utilized to send the timing information and multiple time references for the information. For example, the time shift information may be sent over a cellular communications channel and the time references could be made relative to some unique timing feature of the cellular channels, such as the beginning of a multi-frame burst as occurs in TDMA and CDMA systems. The time shift information could, alternatively, be sent over such a cellular channel and then used relative to the timing or signal synchronization burst time position of a strong digital television signal. In further embodiments, the time shift information may be transmitted over the digital television signal itself and may further be made timing information relative to the synchronization burst time for that digital television signal. In yet further embodiments, the time shift information may be transmitted using the digital television signal but made relative to one or more base station multi-frame starting points, which stations may be identified by their associated base station identification numbers. It will be understood that such timing assistance may be implemented, for example in the manner described for GPS systems in U.S. Pat. No. 6,070,078.

In particular embodiments of the present invention, the digital television signals could include both an identification of channels of other nearby digital television transmitters and relative timing information for the other digital television transmitters. Other ranging sources, in addition to or instead of other digital television transmitters, such as a ranging signal source associated with a wireless communication network in the vicinity of the digital television transmitter, could likewise be identified and relative timing information could be provided for such sources. In such instances, broadcasting of this identification and timing information by the digital television transmitter could enable a receiver to utilize the ranging signals from such a source without being a subscriber of or registering with the wireless communication system.

The flowcharts, flow diagrams and block diagrams of FIGS. 4 through 8 illustrate the architecture, functionality, and operation of possible implementations of systems, methods and computer program products for estimating the position of a mobile terminal according to embodiments of the present invention. In this regard, each block in the flow charts or block diagrams may represent a module, segment, or portion of code, which comprises one or more executable instructions for implementing the specified logical act(s). It should also be noted that, in some alternative implementations, the acts noted in the blocks may occur out of the order noted in the figures. For example, two blocks shown in succession may, in fact, be executed substantially concurrently, or the blocks may sometimes be executed in the reverse order, depending upon the functionality involved.

In the drawings and specification, there have been disclosed typical illustrative embodiments of the invention and, although specific terms are employed, they are used in a generic and descriptive sense only and not for purposes of limitation, the scope of the invention being set forth in the following claims.

That which is claimed is:

1. A method for determining the position of a mobile terminal comprising:
estimating the position of the mobile terminal based on range estimates derived from digital television signals received at the mobile terminal from at least one digital television transmitter and based on range estimates derived from signals received at the mobile terminal from at least one other type of transmitter.

2. The method of claim 1 wherein the digital television signals are a first type of signal and wherein estimating the position of the mobile terminal comprises:
receiving a digital television signal from the at least one digital television transmitter at the mobile terminal;
receiving a second type of signal, different from a digital television signal, from the at least one other type of transmitter at the mobile terminal;
measuring a time of flight for received ones of the digital television signals;
measuring a time of flight for received ones of the second type of signal;
converting the time of flight measurements to range values; and
estimating the position of the mobile terminal using the range values to provide a position estimate based on both the digital television signals and the second type of signal.

3. The method of claim 2 wherein converting the time of flight measurements to range values comprises generating at least three range values.

4. The method of claim 3 wherein a total number of received digital television signals and signals of the second type is greater than three and wherein measuring a time of flight for received ones of the digital television signals comprises selecting at least one of the received digital television signals to use for measuring a time of flight based on a first signal quality criterion and wherein measuring a time of flight for received ones of the second type of signals comprises selecting at least one of the received second type of signals to use for measuring a time of flight based on a second signal quality criterion.

5. The method of claim 4 wherein at least one of the first signal quality criterion and the second signal quality criterion comprises a minimum received signal strength.

6. The method of claim 4 wherein selecting at least one of the received digital television signals to use for measuring a time of flight based on a first signal quality criterion and selecting at least one of the received second type of signals to use for measuring a time of flight based on a second signal quality criterion comprises:
identifying a plurality of received signals having a best signal quality among the received signals, at least one of the plurality of received signals being a digital television signal; and
measuring a time of flight for only the identified plurality of received signals.

7. The method of claim 6 wherein the plurality of received signals comprises less than five received signals.

8. The method of claim 4 wherein the second type of signal is a Global Positioning System (GPS) signal or a downlink signal of a mobile telecommunications network.

9. The method of claim 4 further comprising:
receiving at least one third type of signal, different from a digital television signal and the second type of signal, at the mobile terminal;
measuring a time of flight for received ones of the third type of signal; and
wherein estimating the position of the mobile terminal using the range values to provide a position estimate based on both the digital television signals and the second type of signal comprises estimating the position of the mobile terminal using the range values to provide a position estimate based on the digital television signals, the second type of signal and the third type of signal.

10. The method of claim 9 wherein the third type of signal is a Global Positioning System (GPS) signal and the second type of signal is a downlink signal of a mobile telecommunications network.

11. The method of claim 2 wherein measuring a time of flight for received ones of the digital television signals and measuring a time of flight for received ones of the second type of signal further comprises using a single time measuring unit to measure the respective time of flights for both the digital television signals and the second type of signal.

12. The method of claim 11 wherein the single time measuring unit is located within the mobile terminal and includes a frequency converter and a correlator circuit.

13. The method of claim 1 wherein estimating the position of the mobile terminal based on range estimates derived from digital television signals received at the mobile terminal from at least one digital television transmitter and based on range estimates derived from signals received at the mobile terminal from at least one other type of transmitter comprises estimating the position of the mobile terminal based on at least three range estimates.

14. The method of claim 13 wherein a total number of received digital television signals and received signals from at least one other type of transmitter is greater than the number of range estimates used in estimating the position of the mobile terminal and wherein estimating the position of the mobile terminal further comprises selecting at least one of the received digital television signals to use to generate range estimates used in estimating the position of the mobile terminal based on a first signal quality criterion and selecting at least one of the received signals from at least one other type of transmitter to use to generate range estimates used in estimating the position of the mobile terminal based on a second signal quality criterion.

15. The method of claim 14 wherein at least one of the first signal quality criterion and the second signal quality criterion comprises a minimum received signal strength.

16. The method of claim 14 wherein selecting at least one of the received digital television signals to use to generate range estimates and selecting at least one of the received signals from at least one other type of transmitter to use to generate range estimates comprises:
identifying a plurality of received signals having a best signal quality among the received signals, at least one of the plurality of received signals being a digital television signal; and
generating range estimates for only the identified plurality of received signals.

17. The method of claim 16 wherein the plurality of received signals comprises less than five received signals.

18. The method of claim 17 wherein the received signals from at least one other type of transmitter comprise a Global Positioning System (GPS) signal or a downlink signal of a mobile telecommunications network.

19. The method of claim 14 wherein estimating the position of the mobile terminal based on range estimates derived from digital television signals received at the mobile terminal from at least one digital television transmitter and based on range estimates derived from signals received at the mobile terminal from at least one other type of transmitter comprises estimating the position of the mobile terminal based on range estimates derived from digital television signals received at the mobile terminal from at least one digital television transmitter and based on range estimates derived from signals received at the mobile terminal from a second type of transmitter and based on range estimates derived from signals received at the mobile terminal from a third type of transmitter.

20. The method of claim 19 wherein the received signals from the third type of transmitter comprise a Global Positioning System (GPS) signal and the received signals from a second type of transmitter comprise a downlink signal of a mobile telecommunications network.

21. The method of claim 1 wherein estimating the position of the mobile terminal based on range estimates derived from digital television signals received at the mobile terminal from at least one digital television transmitter and based on range estimates derived from signals received at the mobile terminal from at least one other type of transmitter comprises providing the range estimates to a remote position determination server and receiving the estimate of the position of the mobile terminal from the remote position determination server.

22. The method of claim 2 wherein estimating the position of the mobile terminal based on range estimates derived from digital television signals received at the mobile terminal from at least one digital television transmitter and based on range estimates derived from signals received at the mobile terminal from at least one other type of transmitter comprises providing the time of flight measurements to a remote position determination server and receiving the estimate of the position of the mobile terminal from the remote position determination server and wherein converting the time of flight measurements to range values and estimating the position of the mobile terminal using the range values to provide a position estimate are performed by the remote position determination circuit.

23. A method for determining the position of a mobile terminal comprising:
estimating the position of the mobile terminal based on range estimates derived from digital television signals received at the mobile terminal from at least one digital television transmitter and based on range estimates derived from signals transmitted by the mobile terminal to at least one base station of a mobile telecommunications network.

24. The method of claim 23 wherein estimating the position of the mobile terminal comprises:
receiving a digital television signal from at least one digital television transmitter at the mobile terminal;
transmitting at least one second type of signal to the at least one base station from the mobile terminal;
measuring a time of flight for received ones of the digital television signals;
measuring a time of flight for transmitted ones of the second type of signals received at the at least one base station;
converting the time of flight measurements to range values; and
estimating the position of the mobile terminal using the range values to provide a position estimate based on both the digital television signals and the second type of signals.

25. The method of claim 24 wherein the at least one base station comprises a plurality of base stations and wherein the method further comprises synchronizing clocks associated with the plurality of base stations and with the at least one digital television transmitter.

26. A position determination circuit for a mobile terminal comprising:
a television signal processing circuit configured to process digital television signals received from digital television transmitters;
a second type of signal processing circuit configured to process ranging signals received from an alternate type of transmitter different from the digital television transmitters; and
a position computation circuit that estimates a position of the mobile terminal based on a range estimate to at least one of the digital television transmitters derived from a digital television signal received from the at least one of the digital television transmitters and based on a range estimate to at least one transmitter of the alternate type of transmitter derived from a received ranging signal from the at least one transmitter of the alternate type of transmitter.

27. A position determination circuit for a mobile terminal comprising:
a television signal processing circuit configured to process digital television signals received from digital television transmitters;
a second type of signal processing circuit configured to process ranging signals received from a base station of a mobile telecommunications network; and
a position computation circuit that estimates a position of the mobile terminal based on a range estimate to at least one of the digital television transmitters derived from a digital television signal received from the at least one of the digital television transmitters and based on a range estimate to the base station of a mobile telecommunications network transmitter derived from signals transmitted by the mobile terminal to the base station of a mobile telecommunications network.

28. A mobile terminal comprising:
a receiver configured to receive digital television signals from digital television transmitters and to receive ranging signals from an alternate type of transmitter different from the digital television transmitters;
a television signal processing circuit configured to process the received digital television signals;
a second type of signal processing circuit configured to process the ranging signals received from an alternate type of transmitter different from the digital television transmitters; and
a position computation circuit that estimates a position of the mobile terminal based on a range estimate to at least one of the digital television transmitters derived from a digital television signal received from the at least one of the digital television transmitters and based on a range estimate to at least one transmitter of the alternate type of transmitter derived from a received ranging signal from the at least one transmitter of the alternate type of transmitter.

29. The mobile terminal of claim 28 wherein the position computation circuit comprises a processor that provides the range estimates to a remote position determination server and that receives the estimate of the position of the mobile terminal from the remote position determination server.

30. The mobile terminal of claim 28 wherein the alternate type of transmitter comprises at least one of a Global Positioning System (GPS) satellite or a base station of a mobile telecommunications network.

31. The mobile terminal of claim 30 wherein the base station of a mobile telecommunications network is a terrestrial base station.

32. The mobile terminal of claim 28 wherein the position computation circuit further comprises means for estimating the position of the mobile terminal based on at least three range estimates.

33. The mobile terminal of claim 32 wherein a total number of received digital television signals and received signals from at least one other type of transmitter is greater than the number of range estimates used in estimating the position of the mobile terminal and wherein the position computation circuit further comprises means for selecting at least one of the received digital television signals to use to generate range estimates used in estimating the position of the mobile terminal based on a first signal quality criterion and selecting at least one of the received signals from at least one transmitter of the alternate type of transmitter to use to generate range estimates used in estimating the position of the mobile terminal based on a second signal quality criterion.

34. The mobile terminal of claim 33 wherein at least one of the first signal quality criterion and the second signal quality criterion comprises a minimum received signal strength.

35. The mobile terminal of claim 33 wherein the means for selecting at least one of the received digital television signals to use to generate range estimates and selecting at least one of the received signals from at least one of the received signals from at least one transmitter of the alternate type of transmitter comprises:
identifying a plurality of received signals having a best signal quality among the received signals, at least one of the plurality of received signals being a digital television signal; and
generating range estimates for only the identified plurality of received signals.

36. The mobile terminal of claim 35 wherein the plurality of received signals comprises less than five received signals.

37. The mobile terminal of claim 36 wherein the received signals from the at least one transmitter of the alternate type of transmitter comprise a Global Positioning System (GPS) signal or a downlink signal of a mobile telecommunications network.

38. The mobile terminal of claim 33 wherein the position computation circuit further comprises means for estimating the position of the mobile terminal based on range estimates derived from digital television signals received at the mobile terminal from at least one digital television transmitter and based on range estimates derived from signals received at the mobile terminal from a second type of transmitter and based on range estimates derived from signals received at the mobile terminal from a third type of transmitter.

39. The mobile terminal of claim 38 wherein the third type of transmitter comprises a Global Positioning System (GPS) satellite and the second type of transmitter comprises a base station of a mobile telecommunications network.

40. The mobile terminal of claim 28 wherein position computation circuit further comprises means for using a single time measuring unit to measure the respective time of flights for both the digital television signals and the received ranging signal.

41. The mobile terminal of claim 40 wherein the means for using a single time measuring unit further comprises a frequency converter and a correlator circuit.

42. A method for determining the position of a mobile terminal comprising:
receiving digital television signals from a source digital television transmitter at the mobile terminal, the digital television signals including an identification of at least one other ranging information transmitter in a vicinity of the mobile terminal and a timing relation between a timing of the source digital television transmitter and a timing of the at least one other ranging information transmitter;
receiving ranging signals from the at least one other ranging information transmitter based on the received timing relation; and
estimating the position of the mobile terminal based on range estimates derived from the digital television signals received at the mobile terminal from the source digital television transmitter and from the ranging signals received from the at least one other ranging information transmitter.

43. The method of claim 42 wherein the at least one other ranging information transmitter comprises at least one other digital television transmitter and wherein receiving ranging signals from the at least one other ranging information transmitter based on the received timing relation the ranging signals comprises receiving digital television signals from the at least one other digital television transmitter based on the received timing relation.

44. The method of claim 43 wherein receiving digital television signals from the at least one other digital transmitter comprises acquiring the digital television signals from the at least one other digital transmitter based on the received timing relation.

45. The method of claim 44 further comprising providing the digital television signals from the at least one other digital transmitter to a monitor for viewing.

46. The method of claim 42 wherein the at least one other ranging information transmitter comprises at least one transmitter associated with a wireless communication network.

47. A position determination circuit for a mobile terminal comprising:
a receiver that receives digital television signals from a source digital television transmitter at the mobile terminal, the digital television signals including an identification of at least one other ranging information transmitter in a vicinity of the mobile terminal and a timing relation between a timing of the source digital television transmitter and a timing of the at least one other ranging information transmitter;
a receiver that receives ranging signals from the at least one other ranging information transmitter based on the received timing relation; and
a position computation circuit that estimates a position of the mobile terminal based on range estimates derived from the digital television signals received at the mobile terminal from the source digital television transmitter and from the ranging signals received from the at least one other ranging information transmitter.

48. The circuit of claim 47 wherein the at least one other ranging information transmitter comprises at least one other digital television transmitter and wherein the received ranging signals comprise digital television signals from the at least one other digital television transmitter.

49. The method of claim 48 further comprising a tuner that provides the digital television signals from the at least one other digital transmitter to a monitor for viewing.
